(19) United States
(12) Patent Application Publication
(10) Pub. No.: US 2008/0179487 A1
(43) Pub. Date: Jul. 31, 2008

(54) Bird feeder and plant hanger

(76) Inventor: Steven J. Vigstol, St. Francis, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/699,100

(22) Filed: Jan. 29, 2007

(51) Int. Cl. A01K 97/10

(52) U.S. Cl. 248/534

(57) ABSTRACT

A device for hanging objects from an outside part of a building, including a mast for mounting the device to an outside area of a structure such as a porch, deck, patio and the like. The mast extends upward at least above any railing on the deck. A pivot head is slidably mounted on the mast for rotation about the vertical axis, the pivot head extending horizontally out from the outside area to its extended end. An extension arm has a first end engaging the extended end of the pivot head and a second end for holding a hanger rail for hanging objects such as flower pots and bird feeders thereon.

### FIELD OF THE INVENTION

The present invention relates to an improved bird feeder and plant hanger. More particularly, the invention relates to a device that allows one to hang bird feeders and plants that are inherently messy from one's patio or deck while avoiding the debris that falls from such feeders and planters.

### BACKGROUND OF THE INVENTION

During the growing season, many people like to hang plants from their deck, patio, or other outside areas of their homes. It is also desirable to hang bird feeders, not only during the summer but all year, so the proximity of the birds adds pleasure to the home owner.

When plants and bird feeders and the like hang outdoors, there is an amount of debris that falls, whether as leaves from a plant, dirt washed out from rain or from watering the plants, seeds and droppings from birds that land on the feeder. This leaves a mess on the area below the pots or feeders that is not only a nuisance to clean up but which leaves stains on the deck and/or furniture. If the pots or bird feeders are placed at a point remote from the deck, tending the plants or refilling the feeders is also remote, and when the deck is elevated, may require a ladder or other manner of tending these devices.

It would be of advantage in the art if a device could be provided that would allow one to hang potted plants, bird feeders and the like from a deck, patio, porch or other part of a building in a position that avoided falling debris and other refuse.

Yet another advantage would be if the device could be sufficiently mobile to allow for tending plants, refilling feeders and the like without having to leave the deck.

It would be another advance in the art if the device that holds the plant pots and feeders is simple, easy to use, and does not involve any modification to the deck, patio, porch or other part of the building where it is used.

Other advantages will appear hereinafter.

### SUMMARY OF THE INVENTION

It has now been discovered that the above and other advantages of the present invention may be obtained in the following manner. Specifically, the present invention provides a device for hanging having objects from an outside part of a building. The device includes a mast or pole that is mounted, either fixedly or removably to an outside area of a structure such as a porch, deck, patio and the like.

The mast extends upward at least above any railing on the deck or other area. A pivot head is slidably mounted on the mast for rotation about the vertical axis, so that the pivot head extends horizontally out from the outside area. The mast is preferably cylindrical and the pivot head is also, so that it can fit over or inside the mast cylinder and rotate about the axis.

An extension arm has a first end engaging the extended end of the pivot head and a second end for holding a hanger rail for hanging objects such as flower pots and bird feeders thereon. Each of the components of this invention may be mounted on each other by selecting the appropriate diameters of each component so they are sized to engage the related component. It is desirable that the pivot head can rotate about the axis and, thus, is preferably cylindrical, although other mounting devices such as ball and socket may be used. The other components also rotate and also they can be any shape, such as square, rectangular, triangular and the like.

It is also preferred that each element be mounted to the next element using some form of stop or lock device to prevent separation of any element unless it is desired. In a preferred embodiment, small holes can be drilled in each element such that a hitch pin can be inserted to prevent such undesired movement.

In a preferred embodiment, the device includes one or more stop means, such as a hitch pin, that positions the extension arm and/or the hanger rail in at least one fixed position with respect to the deck or other outside area. Preferably, the stop means provides at least two fixed positions, such as, for example, so the hanger rail can face to the left or the right, depending on the area where it is to be located. A third fixed position is intended to permit the hanger rail to be brought back to the deck or other area for cleaning, pruning, refilling or other service or maintenance needs.

### BRIEF DESCRIPTION OF THE DRAWINGS

For a more complete understanding of the invention, reference is hereby made to the drawings, wherein like numbers refer to like elements, and in which:

FIG. 1 is a top plan view of the device of this invention as installed on a deck of a home:

FIG. 2 is a side, elevational view of the device of FIG. 1;

FIG. 3 is a longitudinal view of the device of FIGS. 1 & 2;

FIG. 4 is a side, elevational view of one component of the device of this invention;

FIG. 5 is a side, elevational view of another component of the device of this invention;

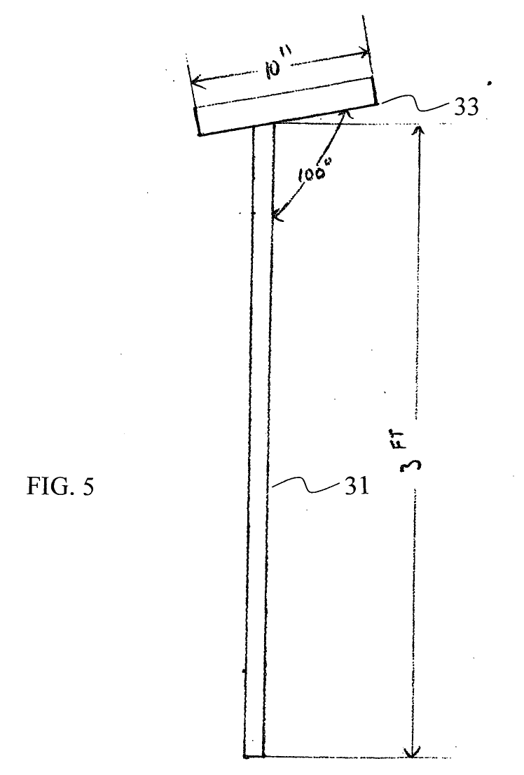

FIG. 6 is a side, elevational view of yet another component of the device of this invention; and

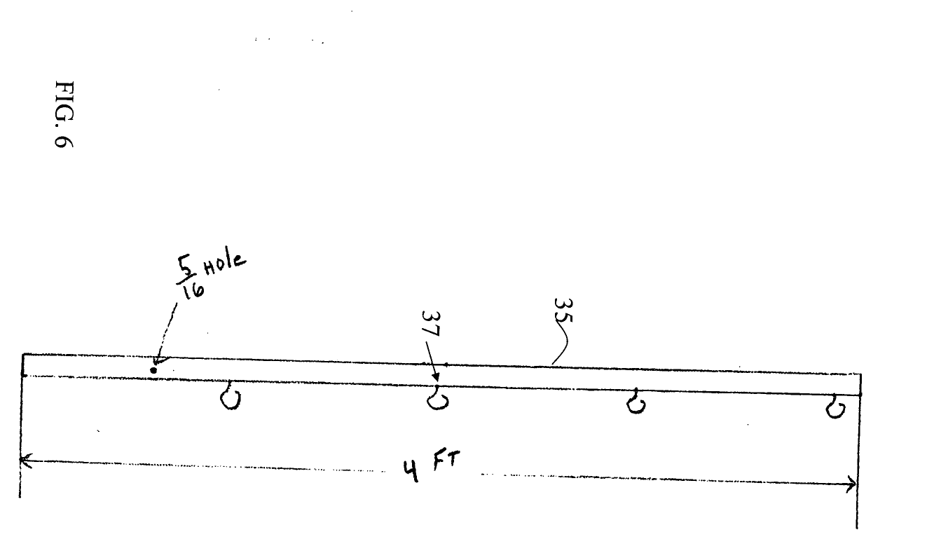

FIG. 7 is a side, elevational view of the final component of the device of this invention.

### DETAILED DESCRIPTION OF THE PREFERRED EMBODIMENT

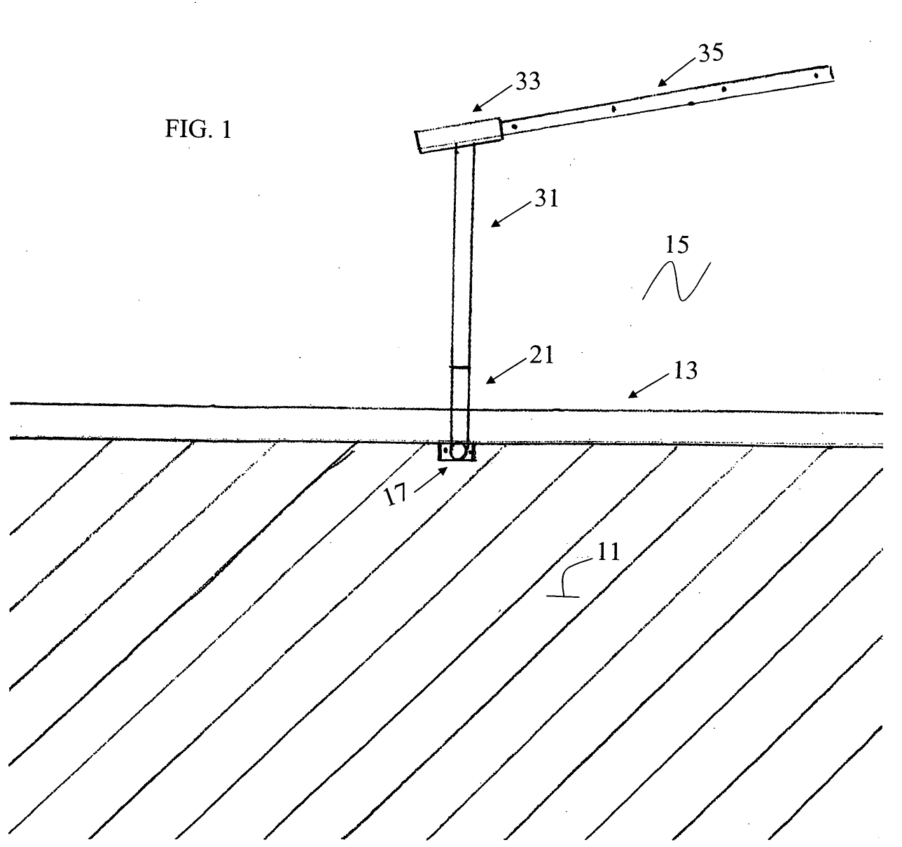

As shown in FIG. 1, the device of this invention is seen from above, as one might when looking out a window from a higher story of the structure. A deck 11 with a rail 13 provides a place for residents of the dwelling to experience the outside environment, such as sitting on the deck or porch. In order to further enjoy the outside area, flower pots, hanging baskets, bird feeders and other elements can be placed proximate the outside area.

As seen in FIGS. 1, 2 and 3, the device 15 generally of this invention extends up from the deck 11 on a mast 17 that is fixedly or removably mounted to deck 11. Mast 17 may also be further attached to the rail 13 via a strap 19 or other mounting device to preserve the vertical orientation of the mast.

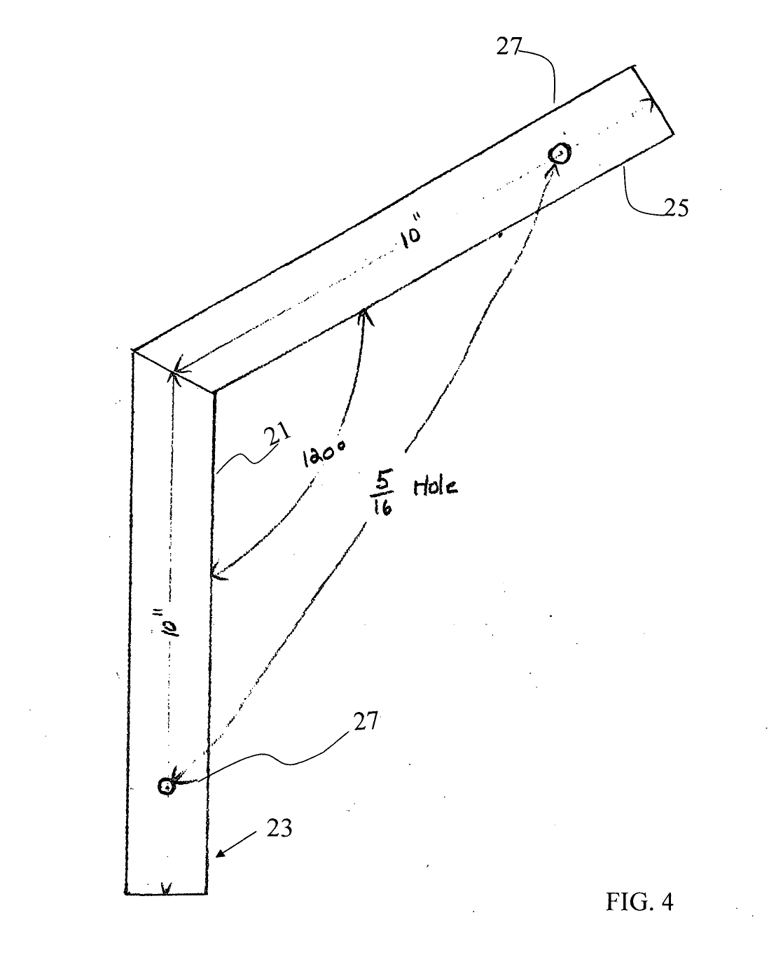

Attached at the upper end of mast 17 is a pivot head 21 extending out from the deck 11 that can rotate about the axis 23 of mast 17. FIG. 4 illustrates the preferred configuration of pivot head 21, with a first end for engaging mast 17 and a second end 25 extending out from mast 17. Holes 27 are provided for mounting pivot head 21 as described below.

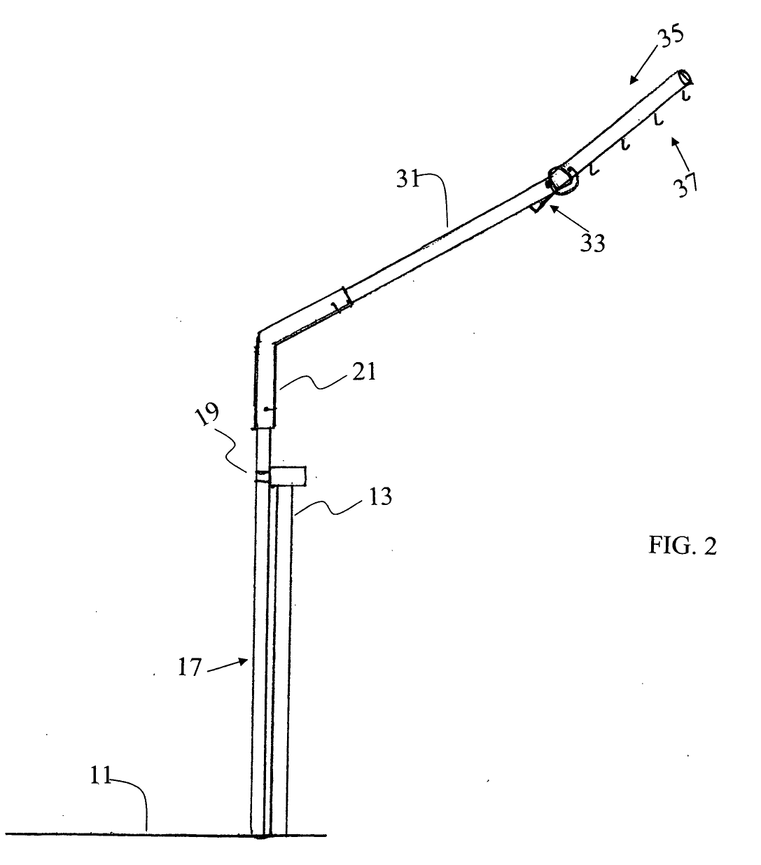

At the outside end 25 of pivot head 21, an extending arm 31 is attached as best seen in FIG. 2, so that the device extends out from deck 11 and any pots of plants, bird feeders or other object carried by the device are spaced from the deck. Rain or watering plants will not drip on to the deck. Leaves and flowers will fall to the ground, rather than on the deck. Debris such as seeds from bird feeders will also not fall on deck 11.

Mounted on the far end of extension arm 31 is a mounting element 33 that is adapted to hold a hanger rail 35 that has one or more hooks 37 that will hang plants, feeders, baskets and the like.

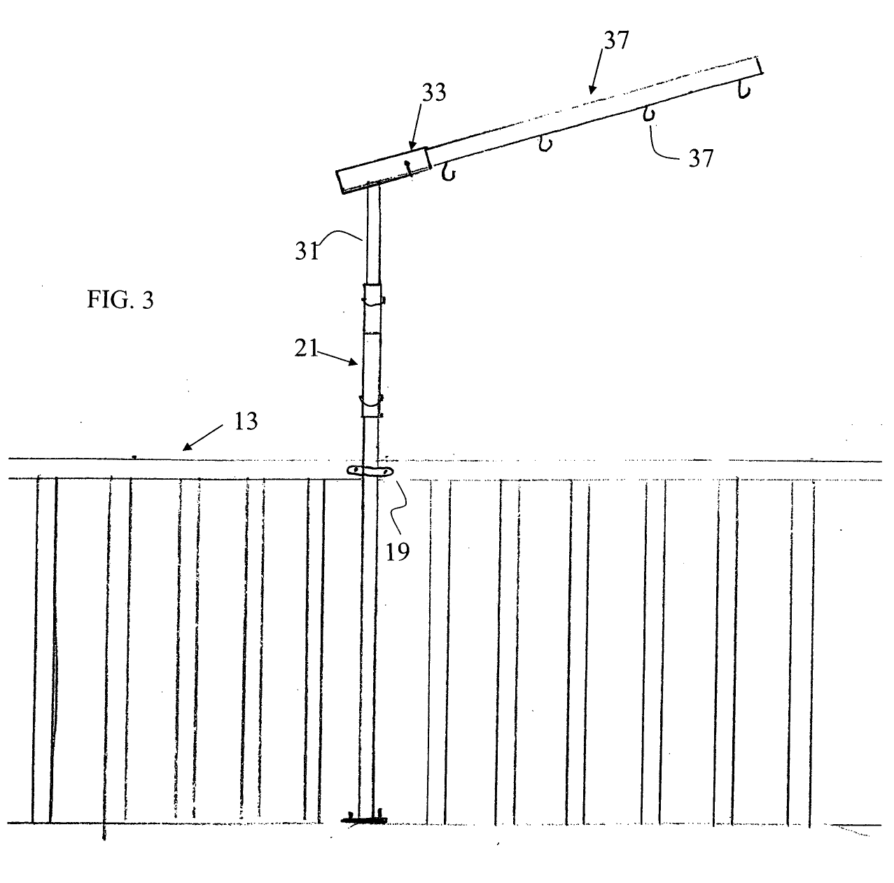

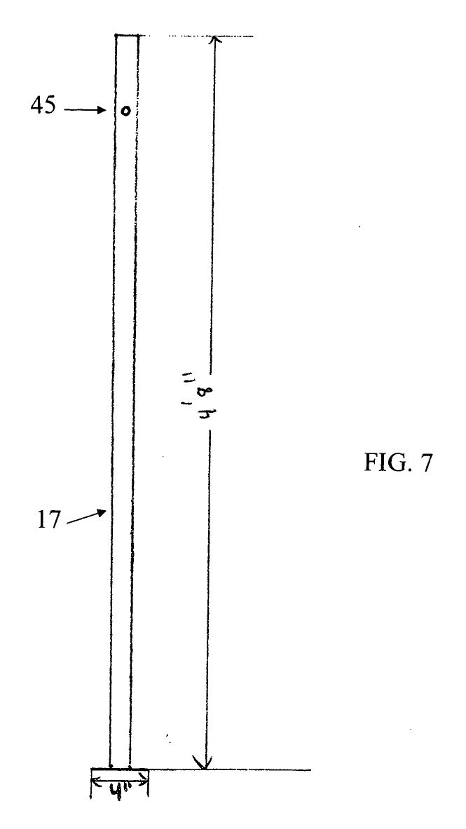

FIGS. 2 and 3 illustrate the use of stop means 41 and 43, which in this embodiment are pins inserted into holes, such as holes 27 of FIG. 4. The mast 17 has a plurality of holes 45 shown partially in FIG. 7 that align with holes 27 of pivot head 21 so that the orientation of the hanger rail 35 can be set, depending on the particular holes 45, so that hanger rail 35 can face to the right, the left, or even straight out from deck 11, and can also be brought to a position over deck 11 for whatever cleaning, maintaining, refilling or other procedures are needed from time to time.

While particular embodiments of the present invention have been illustrated and described, it is not intended to limit the invention, except as defined by the following claims.

1. A device for hanging objects from an outside area of a structure, comprising:
a mast for mounting to an outside area of a structure and extending upward at least above any railing on said area, said mast having a vertical axis;
a pivot head slidably mounted on said mast for rotation about said vertical axis, said pivot head extending horizontally out from said outside area to an extended end thereon;
an extension arm having a first end for engagement with said extended end of said pivot head, said extension arm having a second end; and
a hanger rail for hanging objects thereon, said hanger rail being mounted on said second end of said extension arm and having at least one hook for hanging said objects therefrom.

2. The device of claim 1, wherein said outside area is selected from the group consisting of a deck, porch, patio and landing.

3. The device of claim 2, wherein outside area includes a railing for enclosing at least some of the sides of said area.

4. The device of claim 1, wherein said mast is cylindrical and said pivot head is sized to fit over said mast.

5. The device of claim 1, wherein said hanger rail includes a plurality of hooks for hanging objects therefrom.

6. The device of claim 1, wherein said area includes a rail and said mast is further mounted on said rail to maintain said mast extending upward.

7. The device of claim 1, which further includes a removable stop for engaging said mast and said pivot head to prevent rotation of said pivot head about said axis when said removable stop is so engaged.

8. The device of claim 7, wherein said removable stop includes a first position extending said hanger rail in a first position with respect to said outside area.

9. The device of claim 8, wherein said removable stop includes a second position extending said hanger rail in a second position with respect to said outside area.

10. The device of claim 7, wherein said removable stop includes a position positioning said hanger rail over said outside area for providing access to objects hung on said hanger rail.

11. A device for hanging objects from an outside area of a structure, comprising:
mast means for mounting to an outside area of a structure and extending upward at least above any railing on said area, said mast means having a vertical axis;
pivot head means slidably mounted on said mast means for rotation about said vertical axis, said pivot head means extending horizontally out from said outside area to an extended end thereon;
extension arm means having a first end for engagement with said extended end of said pivot head means, said extension arm means having a second end; and
hanger rail means for hanging objects thereon, said hanger rail means being mounted on said second end of said extension arm means and having at least one hook for hanging said objects therefrom.

12. The device of claim 11, wherein said outside area is selected from the group consisting of a deck, porch, patio and landing.

13. The device of claim 12, wherein outside area includes a railing for enclosing at least some of the sides of said area.

14. The device of claim 11, wherein said mast means is cylindrical and said pivot head means is sized to fit over said mast means.

15. The device of claim 11, wherein said hanger rail means includes a plurality of hooks for hanging objects therefrom.

16. The device of claim 11, wherein said area includes a rail and said mast means is further mounted on said rail to maintain said mast means extending upward.

17. The device of claim 11, which further includes a removable means stop for engaging said mast means and said pivot head means to prevent rotation of said pivot head means about said axis when said removable stop means is so engaged.

18. The device of claim 17, wherein said removable stop means includes a first position extending said hanger rail means in a first position with respect to said outside area.

19. The device of claim 18, wherein said removable stop means includes a second position extending said hanger rail means in a second position with respect to said outside area.

20. The device of claim 17, wherein said removable stop means includes a position positioning said hanger rail means over said outside area for providing access to objects hung on said hanger rail means.
